(19) United States
(12) Patent Application Publication
(10) Pub. No.: US 2010/0114804 A1
(43) Pub. Date: May 6, 2010

(54) REPRESENTATIVE HUMAN MODEL GENERATION METHOD

(75) Inventors: Hee-Cheon You, Pohang-city (KR); Ki-Hyo Jung, Kyungsangbuk-do (KR)

Correspondence Address: LEXYOUME IP GROUP, LLC, 5180 PARKSTONE DRIVE, SUITE 175, CHANTILLY, VA, 20151, US

(73) Assignee: POSTECH ACADEMY-INDUSTRY FOUNDATION, Pohang-city (unknown)

(21) Appl. No.: 12/532,857

(22) PCT Filed: Apr. 26, 2007
(86) PCT No.: PCT/KR2007/002042

§ 371 Date: Sep. 24, 2009

(30) Foreign Application Priority Data
Apr. 18, 2007 (KR) 10-2007-0037881

(51) Int. Cl. G06F 15/18; G06N 5/02

(52) U.S. Cl. 706/12; 706/54

(57) ABSTRACT

A representative human model generation method is provided. The method includes i) setting a design target population, ii) setting a target accommodating percentage of the design target population, iii) converting anthropometric sizes of the design target population to normalized squared distances, iv) setting a boundary region for a target accommodation percentage of the design target population using normalized squared distances, and v) forming a minimum number of clusters satisfying the target accommodation percentage by performing cluster analysis for anthropometric cases contained in the boundary region among the design target population.

### TECHNICAL FIELD

The present invention relates to a representative human model generation method. More particularly, the present invention relates to a representative human model generation method using a statistical approach.

### BACKGROUND ART

Human models representing the diversity of a design target population are used for design and evaluation of anthropometric products. Representative human models (RHMs) are human models that statistically represent the anthropometric diversity of the design target population. When the RHMs are used, design and evaluation of the products can be effectively performed as there is no need to apply huge anthropometric data.

A typical representative human model generation method uses percentiles for each of anthropometric variables. According to this method, the representative human model cannot properly represent the design target population. In addition, when the number of anthropometric variables that will be applied increases, the number of necessary RHMs drastically increases.

A boundary approach has been developed to solve the problem of the percentile method. In the boundary approach, the anthropometric variables are combined to a small number of common factors by factor analysis, and then a small number of RHMs are generated. The boundary approach, however, extracts the common factors by factor analysis so that about 80% of anthropometric size variations can be explained. The remaining 20% of the anthropometric size variations are not considered in generating the RHMs. Therefore, the RHMs generated by the boundary approach cannot also statistically and properly represent the design target population.

### DISCLOSURE

### Technical Problem

To solve the aforementioned problems, an exemplary embodiment of the present invention provides a representative human model generation method that can generates RHMs that properly and statistically represent the design target population.

### Technical Solution

In an exemplary embodiment of the present invention, a representative human model generation method includes i) setting a design target population, ii) setting a target accommodation percentage of the design target population, iii) converting anthropometric sizes of the design target population into normalized squared distances, iv) setting a boundary region accommodating a target accommodation percentage of the design target population using the normalized squared distances, and v) forming a minimum number of clusters satisfying the target accommodation percentage by performing cluster analysis to a population formed by the boundary region among the design target population. The representative human model generation method may include an additional step to generate one representative human model in each cluster.

The conversion of the anthropometric sizes to a normalized squared distance may be performed according to the following mathematical formula.

$$[ Mathematical Formula 1 ]$$

$$D = ( \begin{matrix}\begin{matrix}{AD}_{1} - {μ}_{{AD}_{1}} , \\ {AD}_{2} - {μ}_{{AD}_{2}} , … ,\end{matrix} \\ {AD}_{n} - {μ}_{{AD}_{n}}\end{matrix} ) {Σ}^{- 1} ( \begin{matrix}{AD}_{1} - {μ}_{{AD}_{1}} \\ {AD}_{2} - {μ}_{{AD}_{2}} \\ ⋮ \\ {AD}_{n} - {μ}_{{AD}_{n}}\end{matrix} ) \leq {χ}_{n}^{2} ( 1 - p )$$

where D is the normalized squared distance, ADₙ is a size of a nₜₕ anthropometric variable, μ_{ADn} is a mean value of the nₜₕ anthropometric variable, p is a target accommodating percentage, χₙ²(1−p) is a (1−p)% location of a Chi-square distribution with degrees of freedom of n, and Σ is a covariance matrix of height and weight.

A boundary value of the boundary region satisfies the following mathematical formula.

χₙ²(1−p) Mathematical Formula 2

where n is the number of anthropometric variable and p is the target accommodating percentage.

A K-mean clustering method may be used to perform cluster analysis.

### Advantageous Effects

In the representative human model generating method in accordance with the exemplary embodiment of the present invention, human sizes are converted into normalized squared distances. Therefore, even when the number of anthropometric variables increases, the number of human models does not steeply increase.

In addition, populations having similar human sizes are clustered by cluster analysis. Therefore, the small number of the human models can effectively represent the design target population.

Further, the minimum number of clusters satisfying the target accommodation percentage is formed through the K-mean clustering method. Therefore, the preselected target accommodation percentage can be satisfied for the design target population using a small number of human models.

### DESCRIPTION OF DRAWINGS

FIG. 1 is a flowchart illustrating a RHM generation method according to an exemplary embodiment of the present invention.

FIG. 2 is a graph illustrating a boundary region.

FIG. 3 is a graph illustrating a cluster of anthropometric cases having similar anthropometric sizes.

FIG. 4 is a graph illustrating a result after completing clustering analysis.

FIG. 5 is a graph illustrating the determination of the optimal number of clusters.

### MODE FOR INVENTION

The present disclosure will be described more fully hereinafter with reference to the accompanying drawings, in which exemplary embodiments of the invention are shown. As those skilled in the art would realize, the described embodiments may be modified in various different ways, all without departing from the spirit or scope of the present disclosure. Like reference numerals designate like elements throughout the specification and drawings.

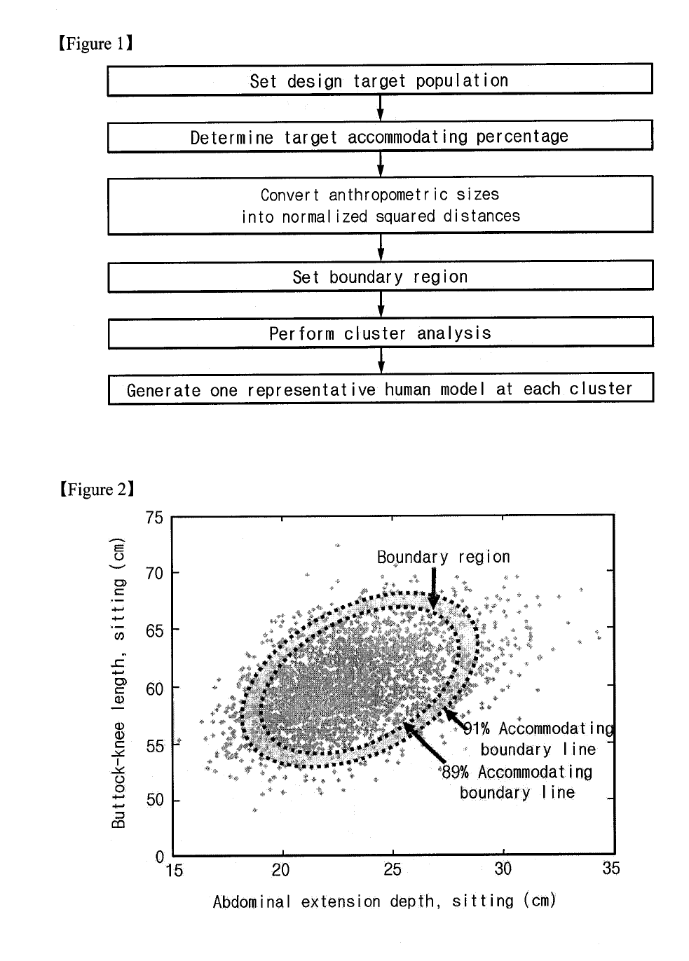

FIG. 1 is a flowchart illustrating a RHM generation method according to an exemplary embodiment of the present invention.

First, a design target population is selected. The design target population is a population for which products are designed. For example, when clothes are designed, the people who will purchase the clothes will be the design target population.

Next, a target accommodation percentage is determined. It would be ideal if the RHM was generated to accommodate all the anthropometric sizes of the design target population. However, since there are deviations between anthropometric sizes of the design target population, it is difficult to accommodate all anthropometric sizes. Therefore, the accommodation percentage (%) of the design target population is determined.

Next, heights and weights of the design target population are converted into normalized squared distances using the following Mathematical Formula 3 using the above Mathematical Formula 1.

$$[ Mathematical Formula 3 ]$$

$$D = ( \begin{matrix}S - {μ}_{s} & W - {μ}_{w}\end{matrix} ) {Σ}^{- 1} ( \begin{matrix}S - {μ}_{s} \\ W - {μ}_{w}\end{matrix} ) \leq {χ}_{n}^{2} ( 1 - p )$$

where L is the normalized squared distance, S is height, W is weight, p is the target accommodation percentage, χₙ²(1−p)% location of a Chi-square distribution with degrees of freedom of 2, μₛ is a mean height, μ_{w} is a mean weight, and Σ is a covariance matrix of height and weight.

There are a variety of anthropometric variables. For example, anthropometric variables include height, chest circumference, arm length, leg length, and the like. That is, the anthropometric sizes follow a multivariate distribution. When RHMs, however, are generated using the multivariate distribution, the number of RHMs dramatically increases as the number of anthropometric variables related to the design increases. Therefore, the anthropometric sizes having the multivariate distribution are converted into normalized squared distances indicating a distance from a center using Mathematical Formula 1. When using the normalized squared distances, a steep increase problem of the number of the RHMs due to an increase of the number of variables can be resolved. The normalized squared distances obtained through Mathematical Formula 1 follow the CM-square distribution.

Next, a boundary region satisfying the designated target accommodation percentage is set using the converted normalized squared distances.

To establish the boundary region, two boundaries are necessary. When the normalized squared distance follows the Chi-square distribution, the boundary accommodating 100p % (p: accommodation percentage, p=0˜1) is formed by Mathematical Formula 2. Therefore, boundaries can be calculated by Mathematical Formula 2. Describing Mathematical Formula 2 again, it is as follows:

χₙ²(1−p)

(where n is the number of anthropometric variables, and p is the target accommodation percentage).

To calculate the two boundaries, the target accommodation percentage is divided into a first percentage (target accommodation percentage+allowable deviation) and a second percentage (target accommodation percentage−allowable deviation) by adding and subtracting the tolerance to and from the target accommodation percentage. For example, when the target accommodation percentage is 90% and the tolerance is 1%, the accommodation percentage is within a range from 89 to 91%. These values are applied to Mathematical Formula 2 to calculate the two boundaries. Meanwhile, the boundary region is a region surrounded by the two boundaries.

Next, cluster analysis is performed for the population in the boundary region. At this point, the minimum number of clusters satisfying the target accommodation percentage is determined while varying the number of clusters. The optimum number of the RHMs can be generated through the above-described cluster analysis. As a cluster analysis method, a K-mean method may be used. The K-mean cluster method is a non-hierarchical cluster method for clustering by repeating a process of sequential clustering. Here, K indicates the number of clusters after completing the clustering. The value of K is predetermined. In the K-mean cluster method, the center of each cluster and the data contained in each cluster are determined to minimize the mean distance of the data from the center of each cluster. In the exemplary embodiment of the present invention, the minimum number of clusters satisfying the target accommodation percentage is found while increasing the number (K) of the clusters by one each iteration.

Next, one RHM is generated at each cluster generated by cluster analysis. The size of the RHM is set as a center of the corresponding cluster or as a data closest to the center of the corresponding cluster.

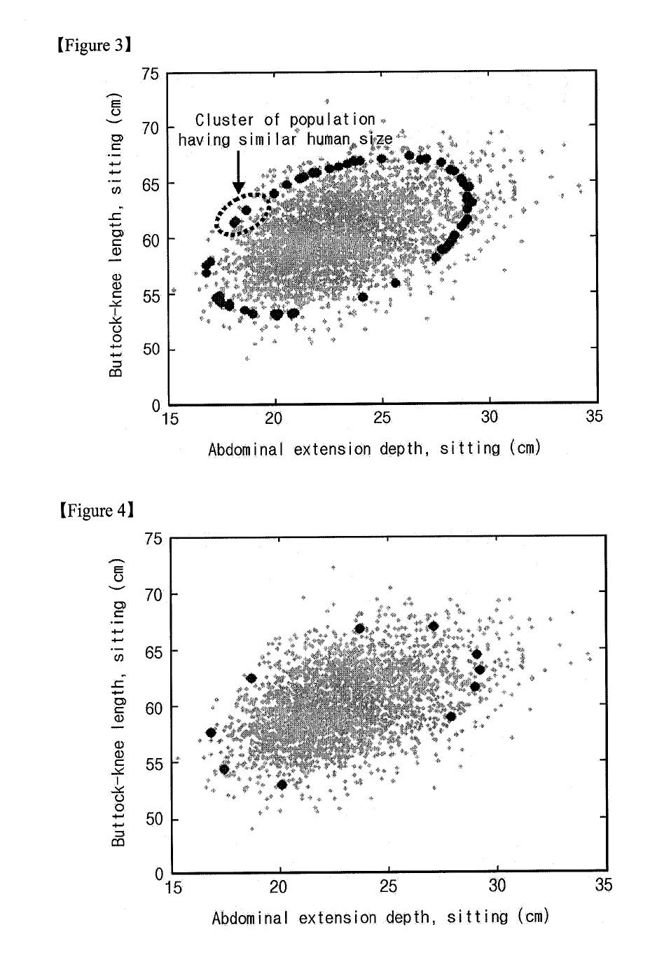

The following will describe an application example of the present invention with reference to FIGS. 2 through 5. In the following application example, anthropometric data of 3982 U.S. soldiers measured in 1988 are used. Abdominal extension depth and buttock-knee length are used as anthropometric variables.

FIG. 2 illustrates a boundary region obtained when the target accommodation percentage is 90%.

When the target accommodation percentage is 90%, a region defined between the boundary lines which respectively accommodate 89% and 91% forms the boundary region. For example, a first person having a height of 182 cm and a weight of 60 kg has a normalized squared distance of 6.28 with respect to the center of the bivariate distribution with the mean height of 175.6 cm and the mean weight of 78.5 kg. A second person having a height of 175.6 cm and a weight of 78.5 kg has a normalized squared distance of 3.31 with respect to the center of the bivariate distribution with the mean height of 175.6 cm and the mean weight of 78.5 kg. A squared distance of the boundary accommodating 90% from a distribution center becomes 4.61. Therefore, the first person (171 cm, 90 kg) of which the normalized squared distance is less than 4.61 is located within the accommodation boundary and the second person (182 cm, 60 kg) is located out of the accommodation boundary line.

FIG. 3 illustrates a cluster of a population having similar anthropometric sizes. As described above, many people having similar anthropometric sizes are contained in the boundary region. Therefore, the anthropometric cases having the similar anthropometric sizes can be effectively clustered by cluster analysis.

FIG. 4 illustrates a result after completing the clustering.

Referring to FIG. 4, it can be noted that the number of clusters of the population can be reduced through clustering. Therefore, the target accommodation percentage can be efficiently satisfied through the minimum number of calculations.

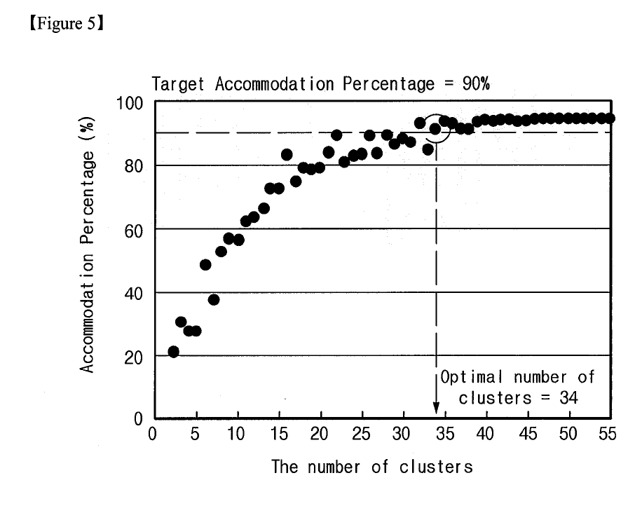

FIG. 5 illustrates a calculation result of the optimum number of the clusters when the target accommodation percentage is 90%. For the design of a workstation 10 anthropometric variables are selected and a boundary region accommodating 89 through 91% of the design target population is determined. In this case, the number of anthropometric cases contained in the boundary region is 55. A population accommodation percentage is analyzed while varying the number of clusters from 2 to 55 by the K-mean clustering method. As a result, when the number of clusters is 34, the target accommodation percentage of 90% for the design target population of 3892 is satisfied. As described above, when the RHM generation method in accordance with the exemplary embodiment of the present invention is used, the target accommodation percentage can be satisfied using the minimum number of clusters.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A representative human model generation method comprising:
setting a design target population;
setting a target accommodation percentage of the design target population;
converting anthropometric sizes of the design target population to normalized squared distances;
setting a boundary region accommodating a target accommodation percentage of the design target population using normalized squared distances; and
forming a minimum number of clusters satisfying the target accommodation percentage by performing cluster analysis for a population contained in the boundary region among the design target population.

2. The representative human model generation method of claim 1, further comprising generating one representative human model at each cluster.

3. The representative human model generation method of claim 1, wherein the converting of the anthropometric sizes to normalized squared distances is performed according to the following mathematical formula:
$$D = ( \begin{matrix}\begin{matrix}{AD}_{1} - {μ}_{{AD}_{1}} , \\ {AD}_{2} - {μ}_{{AD}_{2}} , … ,\end{matrix} \\ {AD}_{n} - {μ}_{{AD}_{n}}\end{matrix} ) {Σ}^{- 1} ( \begin{matrix}{AD}_{1} - {μ}_{{AD}_{1}} \\ {AD}_{2} - {μ}_{{AD}_{2}} \\ ⋮ \\ {AD}_{n} - {μ}_{{AD}_{n}}\end{matrix} ) \leq {χ}_{n}^{2} ( 1 - p )$$
where D is the normalized squared distance, and ADₙ is a size of a nₜₕ anthropometric variable, μ_{ADn} a mean value of the nₜₕ anthropometric variable, p is a target accommodation percentage, χₙ²(1−p) is a (1−p)% location of a Chi-square distribution with degrees of freedom of n, and Σ is a covariance matrix of height and weight.

4. The representative human model generation method of claim 1, wherein a boundary of the boundary region satisfies the following mathematical formula:
χₙ²(1−p)
where n is the anthropometric variable and p is the target accommodating percentage.

5. The representative human model generation method of claim 1, wherein a K-mean clustering method is used to perform cluster analysis.
